(19) United States
(12) Patent Application Publication
(10) Pub. No.: US 2025/0111344 A1
(43) Pub. Date: Apr. 3, 2025

(54) SYSTEMS AND METHODS FOR VIRTUAL AND PHYSICAL TRACKING OF ASSETS

(71) Applicant: Wells Fargo Bank, N.A., San Francisco, CA (US)

(72) Inventor: Prasanth Nandanuru, Seriligampally (IN)

(73) Assignee: Wells Fargo Bank, N.A., San Francisco, CA (US)

(21) Appl. No.: 18/375,638

(22) Filed: Oct. 2, 2023

(51) Int. Cl. G06Q 20/02; G06Q 20/40

(52) U.S. Cl. CPC G06Q 20/027; G06Q 20/401

(57) ABSTRACT

Systems and methods for virtual and physical tracking of assets is provided. A system may receive, from a first node of multiple nodes, a request to perform a transaction of an asset between the first node and a second node of the nodes. Each node may be tokenized representations of a respective physical entity for managing assets. The system may generate a block. The system may transmit the block to each of the nodes. The system may receive, from each of the nodes, a respective message indicating validation of the transaction. The system may append the block onto a blockchain based on receiving the validation. The blockchain may include multiple blocks associated with respective transactions between nodes.

### BACKGROUND

Monetary systems (e.g., banks, asset managing systems, financial institutions) may have multiple access points. For example, a client may store assets (e.g., cash, money, liquid assets) in a bank. To access the cash, the client may go to a physical bank, an automated teller machine (ATM), or a teller cash recycler (TCR), among other monetary systems. Due to the different types of access points, each with a distinct system, it can be challenging to efficiently track and manage transactions in an effective and reliable manner.

### SUMMARY

An aspect of this disclosure can be directed to a system for virtual and physical tracking of assets. The system can include one or more processors coupled with memory. The one or more processors can be configured to receive, from a first node of a plurality of nodes, a request to perform a transaction of an asset between the first node and a second node of the plurality of nodes, wherein each node of the plurality of nodes is a tokenized representation of a respective physical entity for managing assets. The one or more processors can be configured to generate a block comprising: i) a pointer, ii) a block identification, and iii) data associated with the transaction. The one or more processors can be configured to transmit the block to each of the plurality of nodes. The one or more processors can be configured to receive, from each of the plurality of nodes, a respective message indicating validation of the transaction. The one or more processors can be configured to append the block onto a blockchain, the blockchain comprising a plurality of blocks each associated with a respective transaction between two nodes of the plurality of nodes.

An aspect of this disclosure can be directed to a method. The method can include receiving, by one or more processors from a first node of a plurality of nodes, a request to perform a transaction of an asset between the first node and a second node of the plurality of nodes, wherein each node of the plurality of nodes is a tokenized representation of a respective physical entity for managing assets. The method can include generating, by the one or more processors, a block at least comprising: i) a pointer, ii) a block identification, and iii) data associated with the transaction. The method can include transmitting, by the one or more processors, the block to each of the plurality of nodes. The method can include receiving, by the one or more processors from each of the plurality of nodes, a respective message indicating validation of the transaction. The method can include appending, by the one or more processors, the block onto a blockchain based on receiving the validation, the blockchain comprising a plurality of blocks each associated with a respective transaction between two nodes of the plurality of nodes.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A depicts an example system for virtual and physical tracking of assets, according to an arrangement.

FIG. 1B depicts example block diagrams of a computing system, a node, and a virtual provider system, according to an arrangement.

FIG. 2 depicts an example system for virtual and physical tracking of assets, according to an arrangement.

FIG. 3 depicts an example blockchain for virtual and physical tracking of assets, according to an arrangement.

FIG. 4 depicts an example flow chart of a method for virtual and physical tracking of assets, according to an arrangement.

FIG. 5 depicts an example network for virtual and physical tracking of assets, according to an arrangement.

FIGS. 6A and 6B depict example transactions and a notary record system, respectively, according to an arrangement.

FIG. 7 depicts an example flow chart of a method for virtual and physical tracking of assets, according to an arrangement.

FIG. 8 depicts an example method for virtual and physical tracking of assets, according to an arrangement.

FIG. 9 depicts an example system for virtual and physical tracking of assets, according to an arrangement.

### DETAILED DESCRIPTION

Following below are more detailed descriptions of various concepts related to, and implementations of, methods, apparatuses, and systems for detecting television state based on machine learning. The various concepts introduced above and discussed in greater detail below may be implemented in any of numerous ways.

This disclosure is directed to systems, methods, and apparatuses for virtual and physical tracking of assets. Monetary systems may manage assets (e.g., money). Some monetary systems may include multiple access points in the physical world. These access points may be physical entities, such as an ATM, a cash vault, a TCR, a bank, a branch, or a cash deposit recycler (CDR), among other examples. A client may perform a transaction with one of the physical entities to store or retrieve assets from the monetary systems. Because each physical entity may include an independent system and logic for performing and managing transactions, performing a transaction at different physical entities may be challenging to efficiently track the transactions and asset availability. For example, each physical entity may store a respective record of transactions for each client. The physical entities may communicate with each other to reconcile potential differences in the respective records for each client, which may result in complex interfaces, decreased transparency and traceability, increased operational cost, replicated data (e.g., leading to multiple false transactions), among other deficiencies.

This technical solution can overcome the aforementioned technical deficiencies. For example, the technical solution can provide a system by which assets can be moved virtually and physically. To do so, physical entities can be assigned digital tokens (e.g., tokenized, made into a non-fungible token (NFT)) in a virtual landscape (e.g., branch world). The physical entities can be represented using logical legal entities, nodes, or parties, among other examples. For example, each physical entity may correspond to a node, with an identity of each physical entity backed by a digital certificate. Each node may include information about an amount of asset (e.g., cash lines) and a blockchain vault. The blockchain vault may include copies of blockchains, where each blockchain may include blocks (e.g., records) of transactions by a respective client. The nodes may be integrated into a blockchain platform. The blockchain platform may share a same logic and ledger platform to track and manage transactions.

In some cases, because each node may share the same logic and include individual copies of the blockchain, a client may access the blockchain from any physical entity in the system. Additionally, the system may result in a more transparent system, increased security and protection due to the immutable nature of blockchain, increased scalability, reduced operational cost, increased reliability, and integration into virtual landscapes (e.g., a metaverse).

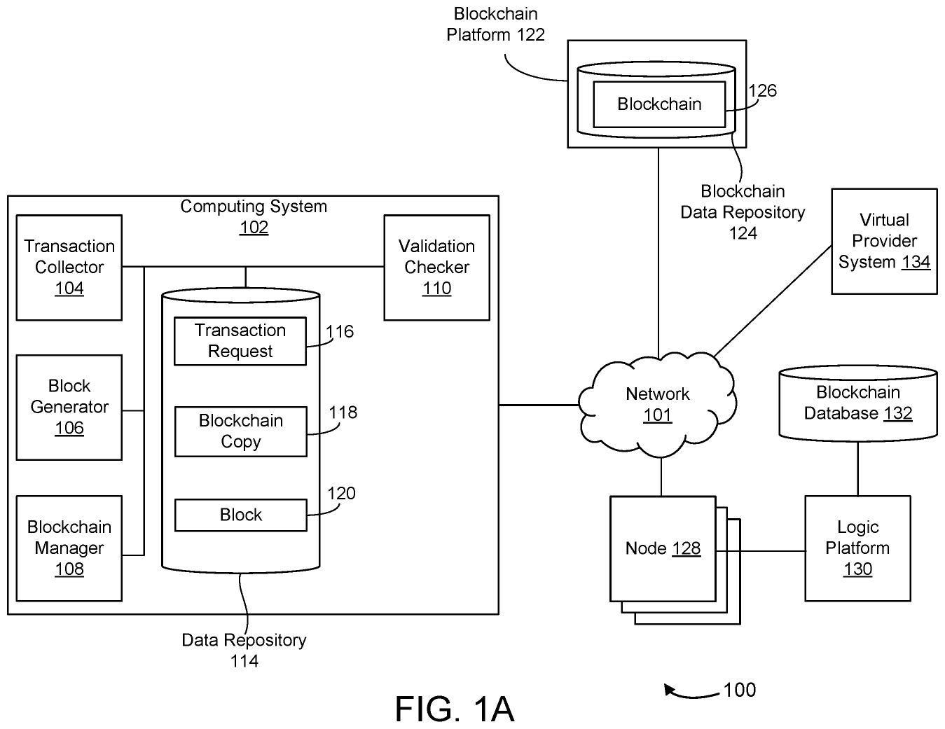

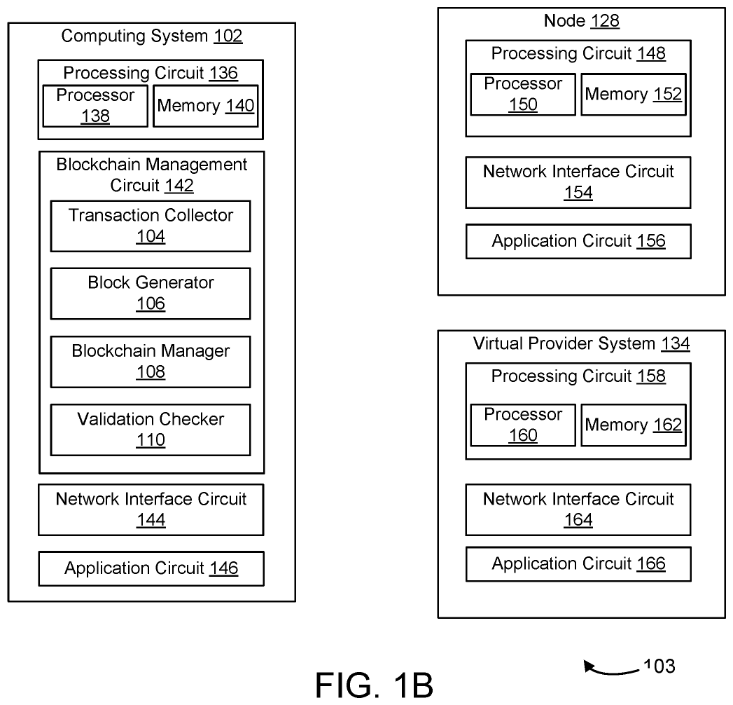

FIG. 1A depicts an example system 100 for virtual and physical tracking of assets, according to an arrangement. The system 100 can include a computing system 102, a blockchain platform 122, a node 128, and a virtual provider system 134. The computing system 102 can include a transaction collector 104 to obtain transaction requests 116 from actors. The computing system 102 can include a block generator 106 to generate a block 120. The computing system 102 can include a block chain manager 108 to append the block 120 onto a blockchain 118 (e.g., a local copy of a blockchain). The computing system 102 can include a validation checker 110 to validate, sign, and confirm validation of the transaction requests 116. The computing system 102 can include a data repository 114 to store and manage data, such as the transaction requests 116, the blockchain copies 118, and the block 120. The blockchain platform 122 can include a blockchain data repository 124 including one or more blockchains 126.

The computing system 102 can interface with, communicate with, or otherwise receive or provide information with one or more of the blockchain platform 122, the nodes 128, or the virtual provider system 134 via the network 101. The computing system 102, the blockchain platform 122, the nodes 128, or the virtual provider system 134 can each include at least one logic device such as a computing device having a processor to communicate via the network 101. The computing system 102, the blockchain platform 122, the nodes 128, or the virtual provider system 134 can include at least one computation resource, server, processor, or memory. For example, the computing system 102 can include a plurality of computation resources or processors coupled with memory. The nodes 128 can be nodes of a distributed network. For example, each of the nodes 128 may include or store a copy of a distributed ledger (e.g., a copy of a database synchronized and accessible across each node 128).

The network 101 can include computer networks such as the Internet, local, wide, metro, or other area networks, intranets, satellite networks, and other communication networks such as voice or data mobile telephone networks. The network 101 can include wired or wireless networks, connections, or communication channels. The network 101 can be used to transmit or receive information or commands to or from various components or sources. The network 101 may be any type or form of network and may include any of the following: a point-to-point network, a broadcast network, a wide area network, a local area network, a telecommunications network, a data communication network, a computer network, an asynchronous transfer mode (ATM) network, a synchronous optical network (SONET) network, a synchronous digital hierarchy (SDH) network, a wireless network, or a wireline network. In some implementations, the network 101 may include quantum channels for transmitting quantum entangled particles including information communicated between the computing system 102, the blockchain platform 122, and the nodes 128.

The computing system 102, the blockchain platform 122, or the nodes 128 can be part of or include a cloud computing environment. The computing system 102, the blockchain platform 122, or the nodes 128 can include multiple, logically grouped servers and facilitate distributed computing techniques. The logical group of servers may be referred to as a data center, server farm, or a machine farm. The servers can also be geographically dispersed. A data center or a machine farm may be administered as a single entity, or the machine farm can include a plurality of machine farms. The servers within each machine farm can be heterogeneous—one or more of the servers or machines can operate according to one or more type of operating system platform. In some implementations, the computing system 102 may be a type of client device, such as a computer, a laptop, a tablet, a phone, or any other type of device including one or more processors and memory capable of performing the functions as described herein. In some implementations, the nodes 128 or the blockchain platform 122 may perform any or all actions or functions performed by the computing system 102. In some implementations, the computing system 102 may perform any or all actions or functions performed by the blockchain platform 122 or the nodes 128.

In some implementations, the computing system 102, the blockchain platform 122, the nodes 128, or the virtual provider system 134 can be part of or include a virtual environment. For example, the virtual provider system 134 may provide a virtual world. To do so, the virtual provider system 134 may support virtual reality (VR), augmented reality (AR), mixed reality (MR), or another type of virtual arrangement. For instance, the virtual provider system 134 may support communication with a head-wearable device, a hand-wearable device, or another device with which a user may use to interact with a virtual world. In some cases, the virtual provider system 134 may communicate information of the virtual world to the head-wearable device for the user to see virtual depictions of physical objects (e.g., virtual entities, virtual objects, avatars) and communicate information to the hand-wearable device for the user to interact with the virtual depictions based on hand movements of the user (e.g., perform actions that a user could perform in a physical world, interact with a virtual ATM as if the client were interacting with a physical ATM).

The virtual provider system 134 may produce a 3D space, a virtual world, a metaverse, etc. The virtual environment may be an AR environment, where non-interactive virtual elements are displayed and viewed with physical elements in a physical space (e.g., a physical world, a real world, a physical reality, a physical environment). In some arrangements, the virtual environment may be a VR environment, wherein interactive virtual elements and the non-interactive virtual elements are displayed and viewed within a virtual space (e.g., a virtual world, a non-physical world). The interactive and the non-interactive virtual elements may graphically depict accurate or inaccurate representations of physical elements in the physical space. In some arrangements, the virtual environment may be an MR environment, having a combination (e.g., a mix) of AR and VR, where the interactive and the non-interactive virtual elements are displayed and viewed with physical elements in a physical space. In some arrangements, the virtual environment may be mapped to an outlined physical space (e.g., a room, a building, a city, a planet, etc.) such that virtual coordinates of the virtual environment can be mapped or matched to (e.g., aligned with, become in-sync with) physical coordinates of the outlined physical space, for example, based on one or more matrices or transform functions that can convert physical coordinates to virtual coordinates, and vice versa. In some cases, each physical entity (e.g., a branch) represented by the nodes 128 may be a mini metaverse that can interact with other branch mini metaverses. For example, an avatar of the user may enter into a first mini metaverse, where the first mini metaverse includes virtual representations of a bank. The avatar may enter into a second mini metaverse, where the second mini metaverse includes virtual representations of an ATM. In this way, the user may interact with various mini metaverses, each including virtual representations of a physical entity that is supported by a node 128. Each party in the branch may include a digital identifier.

The blockchain platform 122 can be remote from the computing system 102. The remote computing system 126 can include or otherwise access the blockchain data repository 124 or database. The blockchain data repository 124 can include one or more blockchains, data files, data structures, arrays, values, or other information that facilitates operation of the blockchain platform 122. The blockchain data repository 124 can include one or more local or distributed databases and can include a database management system.

The blockchain data repository 124 can include, maintain, or manage one or more blockchains 126. The blockchains 126 can include one or more blocks, each of which contains or stores information or data for one or more respective transactions. For example, the blockchain platform 122 can communicate or interact with the computing system 102 and the nodes 128, vice versa. The computing system 102 or the nodes 128 may transmit data (e.g., source ID, destination ID, amount, certificates, blocks) identifying and defining each transaction to the blockchain platform 122. The blockchain platform 122 may append a respective block per transaction onto a respective blockchain 126. For example, the blockchain data repository 124 may store multiple blockchains 126, where each blockchain 126 includes transaction data for a respective client (e.g., an actor or other party). In response to the blockchain platform 122 determining that a transaction is between a node 128 and another party, the blockchain platform 122 may append a block 120 that includes data of the transaction onto a blockchain 126 including transaction data for the other party. In some arrangements, the blockchain platform 122 may send a copy of the block 120 to the nodes 128, the computing system 102, or both, to cause the nodes 128 or the computing system 102 to update a local copy of the blockchain 126. In some arrangements, the blockchain platform 122 may send a copy of the updated blockchain 126 to the nodes 128, the computing system 102, or both.

The transaction collector 104, the block generator 106, the blockchain manager 108, and the validation checker 110 can each communicate with the data repository 114 or database. The computing system 102 can include or otherwise access the data repository 114. The data repository 114 can include one or more data files, data structures, arrays, values, or other information that facilitates operation of the computing system 102. The data repository 114 can include one or more local or distributed databases and can include a database management system. The data repository 114 can include, maintain, or manage the transaction requests 116. The transaction requests 116 can include a source ID and a destination ID of the computing system 102, the nodes 128, or another entity. The transaction requests 116 can include an amount (e.g., a monetary value) for the transaction. In some cases, the transaction requests 116 may include or include information for one or more certificates for validation of the request. The computing system 102 can collect the transaction requests periodically, according to a configured schedule, or based on an event (e.g., an actor filing a request with the system). The data repository 114 can include, maintain, or manage the blockchain copy 118. The blockchain copy 118 may include a chain of blocks, each for a different transaction. The blockchain copy 118 may store historical records for each transaction that has occurred between a first entity and another entity. In some cases, the data repository 114 may store multiple blockchain copies 118, one for each entity (e.g., client, company, party) managed by the computing system 102. The blockchain copy 118 may be periodically updated or updated based on an event (e.g., generating a block 120 based on a validated transaction request 116, receiving an update from the blockchain platform 122). The data repository 114 can include, maintain, or manage the block 120. The block 120 may include data of a transaction request 116. The block 120 may be in the process of being validated and entered onto the blockchain copy 118. If the block 120 fails to be validated (e.g., the nodes 128 do not validate the block 120 or a certificate for the block 120), then the computing system 102 may discard (e.g., delete, remove) the block 120 from the data repository 114. The block 120 may include a pointer (e.g., a hash of a previous block in the blockchain copy 118), a block ID, and data of the transaction (e.g., source ID, destination ID, amount).

The nodes 128 may be tokenized representations of physical entities. For example, the nodes 128 may be non-fungible (e.g., NFT). The nodes 128 may include information of the physical entities (e.g., location, ID, asset amount, name, type). Each node 128 may interface with a blockchain database 132 via a logic platform 130. The logic platform 130 may be a decentralized application with logic configured to manage interactions (e.g., communications) between a node 128 and a blockchain database 132. The blockchain database 132 may include one or more blockchains (e.g., copies of blockchains shared between the nodes 128, the computing system 102, and the blockchain platform 122). The nodes 128 may update the blockchain database 132 via the logic platform 130 based on validation of transaction requests 116.

The transaction collector 104 can be designed, constructed, and operational to obtain (e.g., receive, collect) requests to perform transactions. The transactions may be of an asset between a first node 128 and a second node 128. In some implementations, the transaction collector 104 may collect multiple transaction requests 116 at once. The transaction collector 104 may store the transaction requests 116 in the data repository 114. In some cases, the transaction collector 104 may store the transaction requests 116 in a queue to be processed in response to resources being made available. The transaction collector 104 may obtain the transaction requests 116 from an actor via a physical interface of the computing system 102, via the network 101, or from another medium. For example, a client (e.g., a person, a merchant, a restaurant, a company, an entity) may request for a withdrawal or deposit of money to or from a physical entity (e.g., a branch, a TCR, a cash vault, a bank, an ATM).

The block generator 106 can be designed, constructed, and operational to generate a block 120. The block 120 may include data of the transaction request 116. For example, the data may include an ID of the client (e.g., a source ID for a deposit, a destination ID for a withdrawal), an ID of the physical entity (e.g., a source ID for a withdrawal, a destination ID for a deposit), and an amount for the transaction (e.g., a monetary value expressed in a configured currency). The data may be structured (e.g., configured) according to a data structure configured at the computing system 102. The data structure may include fields (e.g., parameters) for data of the transaction request 116 (e.g., a destination ID field, an amount field, a source ID field). The block 120 may include a pointer to a hash value of a block in the blockchain copy 118. The hash value may be a hash of a previous block (e.g., a most recent block, a block including data of a last transaction) or a previous block ID.

The blockchain manager 108 can be designed, constructed, and operational to append the block 120 onto the blockchain 118. The blockchain manager 108 can append the block 120 onto the blockchain 118 responsive to validating the block 120 (e.g., validating the transaction request 116 of the block 120). In some cases, the blockchain manager 108 can update the blockchain 118 based on receiving a copy of the blockchain 126. The blockchain 118 may be a same blockchain shared between each of the nodes 128 and the blockchain platform 122.

The validation checker 110 can be designed, constructed, and operational to validate, sign, and confirm validation of the transaction requests 116. The validation checker 110 may use a public key infrastructure (PKI) to validate, sign, and confirm validation of the transaction requests 116. For example, the validation checker 110 may be a certificate authority (CA). The validation checker 110 can issue a certificate for the transaction request 116 and sign the certificate with a private key of the computing system 102. The validation checker 110 may transmit the certificate (and any other data of the transaction request 116, the block 120) to the nodes 128 for validation. The nodes 128 may parse the certificate for information (e.g., name, subject, public key, signature) that supports the validity of the transaction request 116. The nodes 128 may verify the certificate via the public key. In some cases, the nodes 128 may be configured with the public key. The nodes 128 may sign the certificate with a respective private key. The nodes 128 may transmit the signed certificate (e.g., the certificate with a signature from the computing system 102 and the node 128) to the computing system 102. The validation checker 110 may receive the certificate and determine whether the certificate (e.g., the transaction request 116) was validated by the nodes 128. If the nodes 128 did not sign the certificate, the validation checker 110 may determine the transaction request is an invalid request. If the certificate is signed, the validation checker 110 may determine the transaction is a valid request and send an indication to the blockchain manager to append the block 120 onto the blockchain 118.

FIG. 1B depicts example block diagrams of a computing system 102, a node 128, and a virtual provider system 134. The computing system 102 may include a processing circuit 136, a blockchain management circuit 142, a network interface circuit 144, and an application circuit 146. The node 128 may include a processing circuit 148, a network interface circuit 154, and an application circuit 156. The virtual provider system 134 may include a processing circuit 158, a network interface circuit 164, and an application circuit 166. While various circuits, interfaces, and logic with particular functionality are shown, it should be understood that each of the computing system 102, the node 128, or the virtual provider system 134 can include any number of circuits, interfaces, and logic for facilitating the functions described herein. For example, the activities of multiple circuits may be combined as a single circuit and implemented on a same processing circuit (e.g., processing circuit 136, 148, and 158), as additional circuits with additional functionality are included.

The processing circuits 136, 148, and 158 may include at least one respective processor 138, 150, or 160 and at least one respective memory 140, 152, or 162. The processors 138, 150, and 160 may be implemented as a general-purpose processor, a microprocessor, an Application Specific Integrated Circuit (ASIC), one or more Field Programmable Gate Arrays (FPGAs), a Digital Signal Processor (DSP), a group of processing components, or other suitable electronic processing components. In some arrangements, the processors 138, 150, and 160 may be a multi-core processor or an array (e.g., one or more) of processors. The processors 138, 150, and 160 may be configured to perform operations for virtual and physical tracking of assets.

The memories 140, 152, and 162 (e.g., Random Access Memory (RAM), Read-Only Memory (ROM), Non-volatile RAM (NVRAM), flash memory, hard disk storage, optical media, etc.) may store data and/or computer instructions/code for facilitating at least some of the various processes described herein. The memories 140, 152, and 162 may include tangible, non-transient volatile memory, or non-volatile memory. The memories 140, 152, and 162 may store programming logic (e.g., instructions/code) that, when executed by the respective processors 138, 150, and 160, may control the operations of the computing system 102, the node 128, and the virtual provider system 134. In some arrangements, the processors 138, 150, and 160 and the memories 140, 152, and 162 form various processing circuits described with respect to the computing system 102, the nodes 128, and the virtual provider system 134. The instructions include code from any suitable computer programming language such as, but not limited to, C, C++, C#, Java, JavaScript, VBScript, Perl, HTML, XML, Python, TCL, and Basic.

The computing system 102, the node 128, and the virtual provider system 134 include a respective network interface circuit 144, 154, and 164 configured to establish a communication session with another device for sending and receiving data over a network. Accordingly, the network interface circuits 144, 154, and 164 may include a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some arrangements, the computing system 102, the node 128, and the virtual provider system 134 may include a plurality of network interface circuits 144, 154, or 164 of different types, allowing for connections to a variety of networks, such as local area networks or wide area networks including the Internet, via different sub-networks.

The application circuits 146, 156, and 166 may execute an application, software, firmware, or code for which asset tracking operations are needed to receive transactions, generate blocks, transmit blocks, receive validation, append blocks onto a blockchain encrypt data, decrypt data, provide a virtual environment, sign data, verify data, signcrypt data, and so on. For example, the application circuits 146, 156, and 166 can execute a mobile banking application, a browser, a word processing application, a mobile banking application, a mobile wallet, a Graphic User Interface (GUI), an email reader/client, a File Transfer Protocol (FTP) client, a virtual machine application and so on. For example, the application circuits 146, 156, and 166 can execute an application, software, firmware, or code for tracking assets.

The computing system 102 includes a blockchain management circuit 142 that is configured to perform tracking operations of the computing system 102. For example, the blockchain management circuit 142 can include the transaction collector 104 to obtain transaction requests 116, the block generator 106 to generate a block 120, the blockchain manager 108 to append the block 120 onto the blockchain 118, and the validation checker to validate, sign, and confirm validation of the transaction requests 116, as described herein with reference to FIG. 1A.

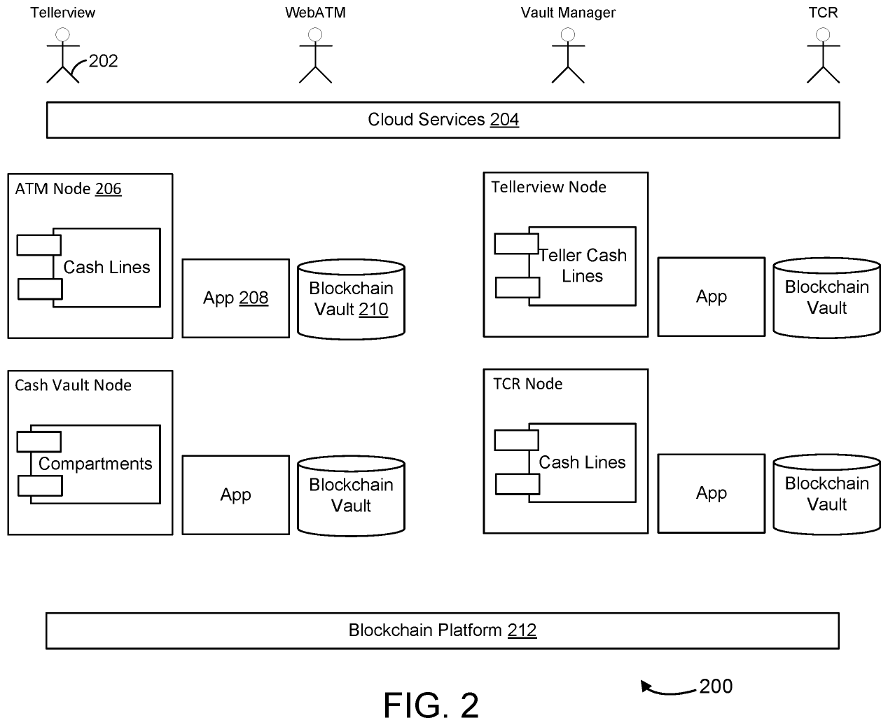

FIG. 2 depicts an example system 200 for virtual and physical tracking of assets, according to an arrangement. The system 200 may include actors 202 (e.g., a physical entity), cloud services 204, multiple nodes 206, a respective application 208 per node 206, a respective blockchain vault 210 per node 206, and a blockchain platform 212. In some cases, the actors 202 may be a merchant, a client, a physical entity, or another entity that has ownership of stored assets. The cloud services 204 may allow the actors 202 to access or interface with the blockchain platform 212 and the nodes 206. The cloud services 204 may be computing systems, applications, interfaces, and/or network systems. The nodes 206 may make a blockchain ecosystem that interacts with the blockchain platform 212 and stores local copies of blockchains within the blockchain platform 212. The cloud services 204, the nodes 206, the application 208, the blockchain vault 210, and the blockchain platform 212 may be respective examples of the network 101, the nodes 128, the logic platform 130, the blockchain database 132, and the blockchain platform 122, as described herein with reference to FIG. 1.

In some cases, an actor 202 may initiate a transaction (e.g., a withdrawal, a deposit) between the actor 202 and a node 206. For example, the actor 202 refers to a user (e.g., operator, client) and an associated device which the user operates. The actor 202 may send a request via the cloud services 204 to withdraw money from a physical entity associated with the node 206 (e.g., the node 206 is a tokenized representation of the physical entity). The request may include a source ID (e.g., an identification of the actor 202, a name), an amount, and a destination ID (e.g., an identification of the node 206). The cloud services 204 may verify the request and sign the request (e.g., generate a signed certificate). The cloud services 204 may transmit the request (e.g., the certificate for the request) to each node 206 in the blockchain ecosystem for verification. The nodes 206 may verify the request and sign the request with a respective signature (e.g., generate a signed certificate). The nodes 206 may transmit, to the cloud services 204, an indication of the respective signatures.

The cloud services 204 may generate a block including data of the transaction. The block may include the source ID, the destination ID, the amount, a pointer to a hash of a previous block within a blockchain for the actor 202, and a block ID, among other data. Responsive to receiving the indication of the respective signatures, the cloud services 204 may append the block onto a blockchain for the actor 202 via the blockchain platform 212. For example, the blockchain platform 212 may include multiple blockchains. Each blockchain may be for a respective actor 202, a node 206, or another entity. For instance, a first blockchain for the actor 202 may include blocks of each transaction the actor 202 has requested. In this way, the first blockchain may include historical data dating back to a first transaction requested by the actor 202, up to a most recent transaction. The cloud services 204 may transmit the block to the blockchain platform 212 for the blockchain platform 212 to append onto the first blockchain for the actor 202. The blockchain platform 212 may transmit a copy of the first blockchain to each node 206. The node 206 may interact with the app 208 (e.g., logic to manage and interact with the block chain copy) to update the stored blockchain copy of the first blockchain in the blockchain vault 210.

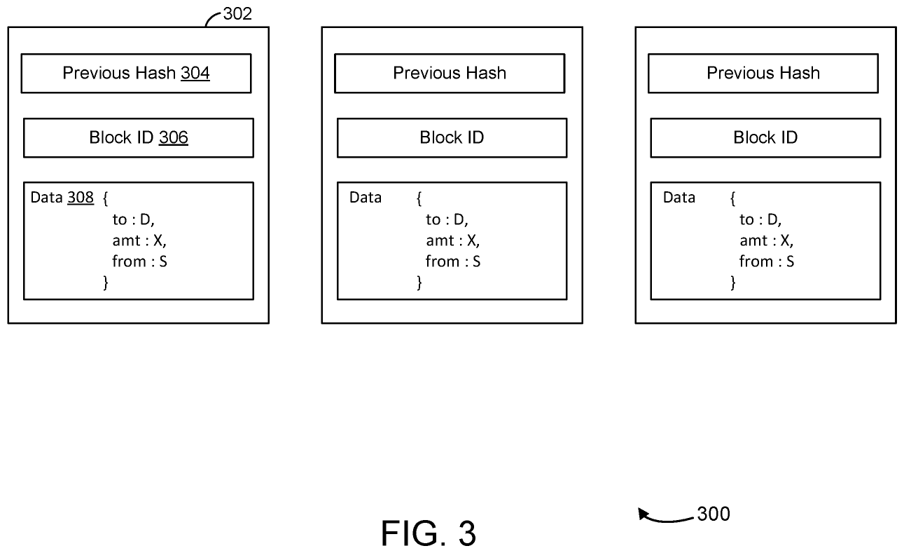

FIG. 3 depicts an example blockchain 300 for virtual and physical tracking of assets, according to an arrangement. The blockchain 300 may include a multiple blocks 302, where each block 302 includes a pointer to a previous block, a block identification (ID), and block data. For example, a first block 302 may include a previous hash 304. The previous hash 304 may be a hash of a previous block ID. The first block 302 may include a block ID 306. The block ID 306 may be a unique ID to identify the first block 302. The first block 302 may include data 308. The data 308 may be structured according to a data structure. For instance, the data structure (e.g., a JavaScript object notation (JSON) data structure) may include parameters for a destination ID, an amount, and a source ID.

In some cases, the first block 302 may include data of a first transaction. The first transaction may be between a client and a physical entity. For example, the client may withdraw money (e.g., united states dollar (USD), euros, other types of currency) from the physical entity. The data 308 of the first block 302 may include {to: D, amt: X, from: S}, where D is a destination ID of the client, X is the amount of money to be withdrawn, and S is a source ID of the physical entity.

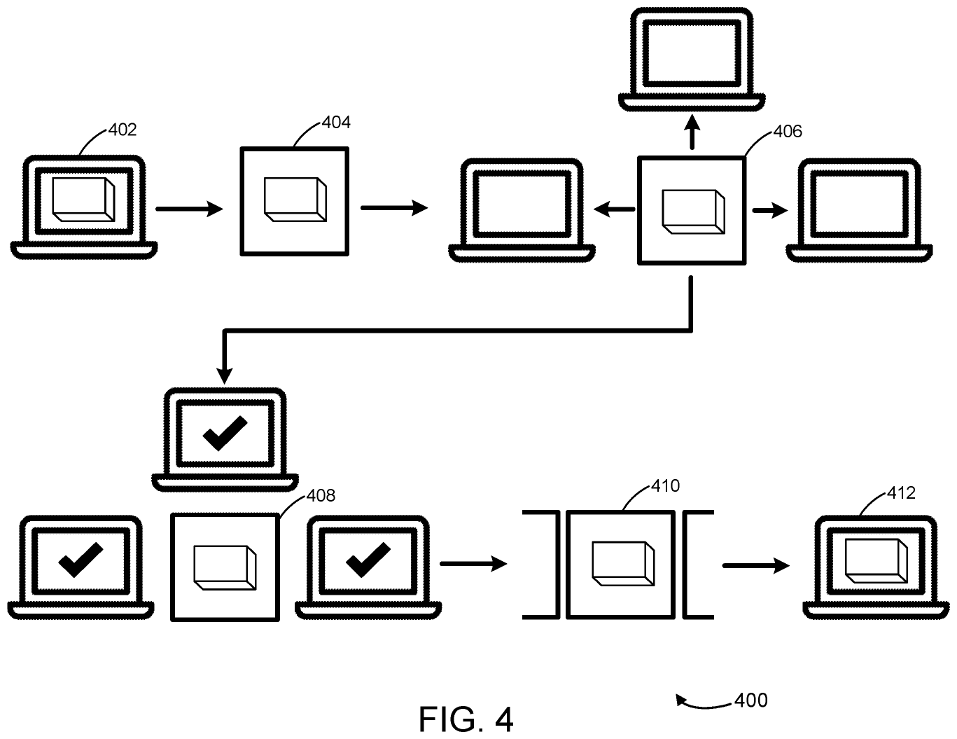

FIG. 4 depicts an example flow chart 400 of a method for virtual and physical tracking of assets, according to an arrangement. The flow chart 400 can be performed by one or more systems or components depicted in FIGS. 1-7, including, for example, a computing system 102, a blockchain platform 126, or a node 130. The method 400 may include more or fewer operations and the operations may be performed in any order.

At operation 402, a computing system may request a transaction. For example, a client may request to withdraw money from an asset managing system (e.g., a physical entity, a web ATM, etc.). At operation 404, the computing system may generate a block. For example, the block may be an example of a block 302, as described herein with reference to FIG. 3. The block may represent the transaction. The computing system may sign the transaction using a private key of the computing system.

In some cases, the computing system may sign the transaction based on a PKI. For instance, in a PKI, a CA can issue a certificate (e.g., a digital certificate, a public key certificate) having a subject for a subscriber. That is, in a PKI, a CA can issue a signed certificate associating a subject with a public key. A signature by the CA on the certificate can bind a name of the CA (e.g., the subscriber, a name of the subject), and a public key of the subject together, along with other certificate information. A party that receives the certificate of the subject/subscriber may obtain from the certificate the issuing entity (e.g., the CA), the subject, and the subject public key. In some cases, the party may also receive one or more CA certificates to obtain one or more public keys of the PKI to validate the certificate chain and verify the certificate of the subscriber. Upon establishing trust in the certificate, the subscriber and the receiving party can establish other cryptographic keys, exchange or communicate encrypted data, signed messages, digital signatures, and so on. In some cases, the computing system may include a CA, where signing the transaction includes signing a certificate with a private key of the CA, the certificate for the transaction. The certificate may include a subject (e.g., a name of an individual, a company, an organization, device, node, entity), a public key, and a signature.

At operation 406, the computing system may broadcast (e.g., transmit, send, transfer) the block to each node (e.g., each party, each asset managing system). Each node may be in a same blockchain network. Each node may access a blockchain platform (e.g., the blockchain platform 212). Each node may be a part of a virtual landscape for tracking and managing assets. To securely broadcast the block to each node, the computing system may encrypt the block with a key, where the computing system may establish the key using a quantum key distribution (QKD) protocol (e.g., BB84, E91). For example, the computing system may include a quantum circuit. The quantum circuit may generate a stream of quantum particles (e.g., quantum bits, qubits), such as photons containing information such as a string of binary zeroes and ones of the block. The computing system may broadcast the quantum particles via a quantum channel to each node. By broadcasting according to the QKD protocol, the transmitted information may be secured due to properties of quantum entangled particles (e.g., if an eavesdropper attempts to read the quantum entangled particles, the entanglement is destroyed, and the eavesdropper will receive a different interpretation). In some cases, communication with the blockchain, communication with a node, communication with a blockchain platform, or any other type of communication for tracking transactions may use quantum particles.

At operation 408, the computing system may receive verification for the transaction from each node. For example, each node may verify the transaction. To do so, each node may verify the signature of the transaction using a public key. Each node may parse the content in the certificate to verify certain aspects of the content of the certificate (e.g., validity dates, key usage). Upon successful verification of the content, each node may sign a second certificate for the transaction using a respective private key of each respective node. In some cases, each node may include an X.509 certificate. Each node may transmit an indication (e.g., a nod) to the computing system indicating verification of the transaction. At operation 410, the computing system may append the block onto an existing blockchain. In some cases, the computing system may generate a new block including data of the transaction to append onto the blockchain. At operation 412, the computing system, and each node, may update a respective copy of the blockchain to include the new block. By updating each node to include the respective copy of the blockchain, the method may result in real time (e.g., close to real time) traceability of transactions being performed by any node (e.g., any physical entity being represented by any node). Additionally, the method may result in more efficient auditing and transparency.

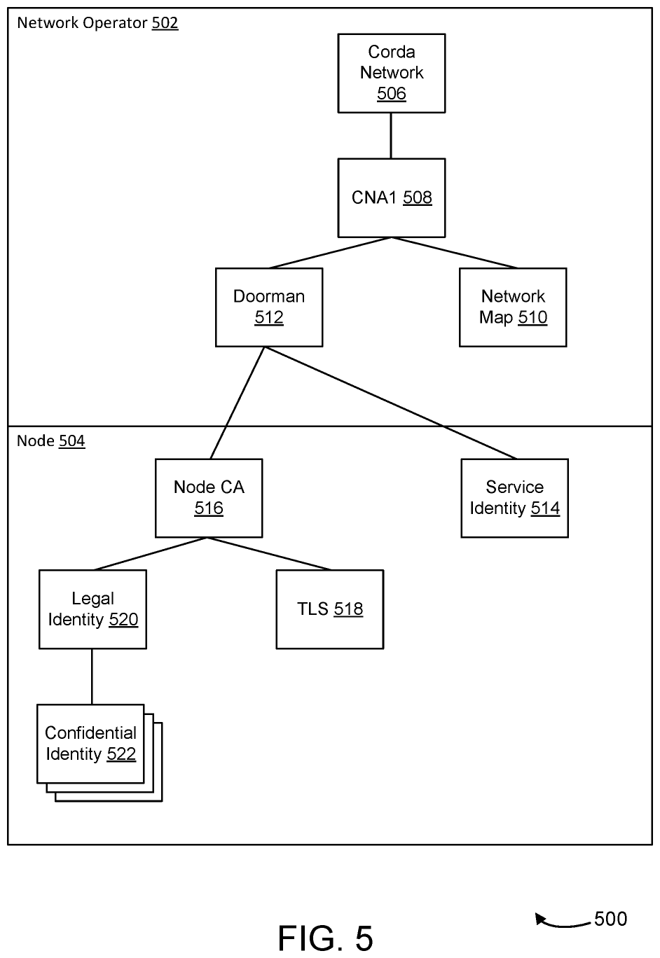

FIG. 5 depicts an example network 500 for virtual and physical tracking of assets, according to an arrangement. The network 500 may be an example of a blockchain network (e.g., a Corda network). The network 500 may include a network operator 502 and a node 504. The network operator 502 may include a corda network component 506, a CNA1 component 508, a doorman component 512, and a network map component 510. The node 504 may include a node CA component 516, a service identity component 514, a legal identity component 520, a transport layer security (TLS) component 518, and a confidential identity component 522. The network 500 may include more or fewer components. The network 500 may include a certificate hierarchy.

The network 500 may include multiple types of CAs. For example, the network 500 may include a root network CA that defines the extent of a compatibility zone, a doorman CA that is used for day-to-day key signing (e.g., an intermediate certificate), and each node may be a CA (e.g., issuing child certificates to sign identity keys and TLS certificates). Each certificate may include an X.509 extension that defines the certificate/key role in the system (e.g., guaranteeing uniqueness in the network). In some implementations, the corda network component 506 may be a network root that issues, via the CNA1 component 508, the doorman certificate to the doorman component 512. The doorman component 512 may sign node certificates. The doorman component may issue a certificate to the service identity component 514. The service identity component 514 may include a service identity that is a known (public) identity of a clustered service (e.g., a notary). The doorman component 512 may issue a certificate marked as node CA to the node CA component 516. The Node CA component 516 may issue the certificate marked as node CA to the legal identity component 520 and the TLS component 518. In some cases, the legal identity component 520 may issue a certificate marked as known legal identity to the confidential identity component 522 as one or more confidential identity certificates.

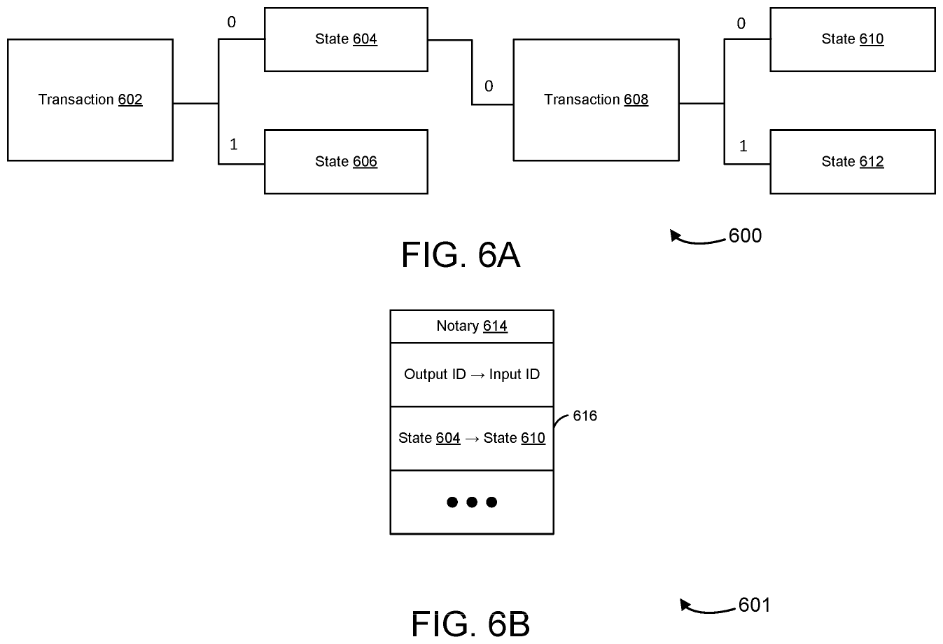

FIGS. 6A and 6B depict example transactions 600 and a notary record system 601, respectively, according to an arrangement. With reference to FIG. 6A, the transactions 600 may include a first transaction 602 and a second transaction 608. The first transaction 602 may include a first output and a second output and the second transaction 608 may include a third output and a fourth output. The first output may for a first state 604, the second output may be for a second state 606, the third output may be for a third state 610, and the fourth output may be for a fourth state 612. The first state 604 may be a first input to the transaction 608. Each transaction 602 and 608 may include two outputs, where each output may have an output index (e.g., 0, 1).

In some cases, the first transaction 602 may be between a first actor and a second actor. For example, the first actor may receive ten dollars from the second actor. The first state 604 may indicate an amount of money the first actor has after the transaction (e.g., $10). The second state 606 may indicate an amount of money the second actor has after the transaction (e.g., $0). The first state 604 and the second state 606 may include unique state IDs. For example, the first state 604 may include a state ID of (Tx1, 0) and the second state 606 may include a state ID of (Tx1,1), where Tx1 indicates a transaction number (e.g., a transaction ID for the first transaction) and the 0 or 1 indicates the output index.

In some cases, the second transaction 608 may be between the first actor and a third actor. For example, the first actor may give two dollars to the third actor. The third state 610 may indicate an amount of money the third actor has after the transaction (e.g., $2). The fourth state 612 may indicate an amount of money the first actor has after the transaction (e.g., $8). The third state 610 may include a state ID of (Tx2, 0) and the fourth state 612 may include a state ID of (Tx2, 1).

With reference to FIG. 6B, the notary record system 601 may include a notary database 614 (e.g., a table, a relational database) for the first actor. The notary database 614 may include a record 616. The record 616 may include data (e.g., a historic state) indicating the first state 604 and the third state 610. For example, the data may include an output state ID and an input state ID. The output ID may be (Tx1, 0) and the input ID may be (Tx2, 0). In this way, the notary record system 601 may store records of unique IDs for a historic state of an asset of the first actor. The notary record system 601 may not store the IDs (Tx1, 1), (Tx2, 0), and (Tx2, 1) because the IDs are not historic to the first actor (e.g., the IDs are of the second and third actors). If another transaction occurred, the notary record system 601 may store a second record 616 including (Tx2, 1) as the output ID and (Tx3, N) as the input ID, where N is either 0 or 1.

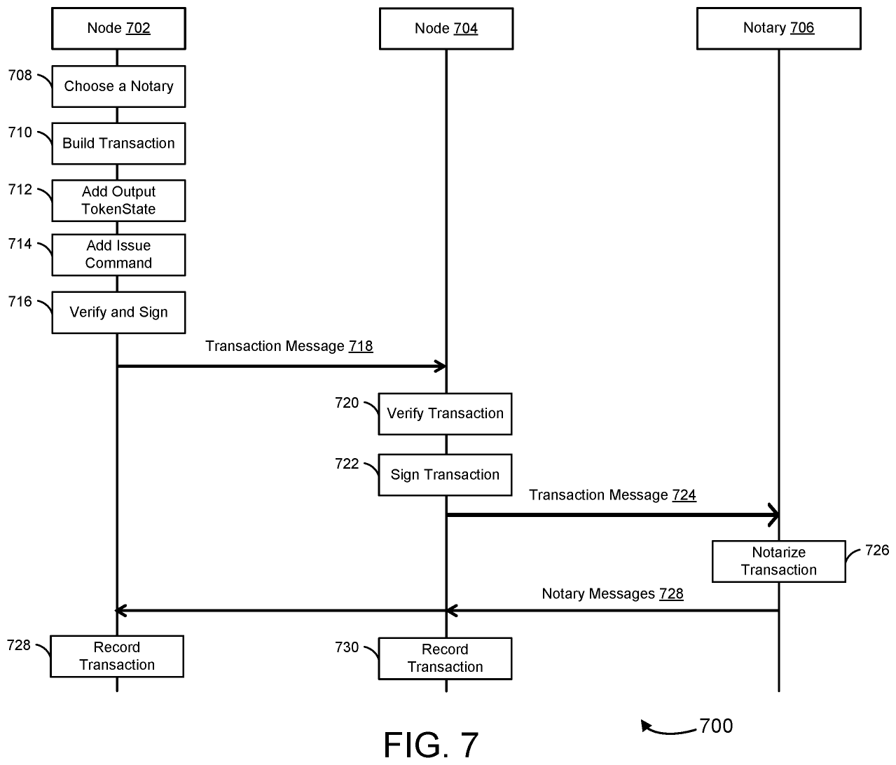

FIG. 7 depicts an example flow chart 700 of a method for virtual and physical tracking of assets, according to an arrangement. The flow chart 700 may include a first node 702, a second node 704, and a notary system 706. The first node 702, the second node 704, and the notary system 706 may be in communication (e.g., wireless communication, wired communication, electronic communication) with each other.

At operation 708, the first node 702 may choose a notary service. The notary service may be preconfigured for the first node 702. The first node 702 may select the notary service from a list of notary services. At operation 710, the first node 702 may build a transaction. The transaction may include a source ID, a destination ID, and an amount to be transferred. At operation 712, the first node 702 may add an output token state. The output token state may include the states as described herein with reference to FIG. 6. At operation 714, the first node 702 may add an issue command. At operation 716, the first node 702 may verify and sign the transaction (e.g., a certificate for the transaction), as described herein with reference to FIG. 4. At operation 718, the first node 702 may transmit a transaction message 718 to the second node 704. The transaction message 718 may include a transaction request, the transaction, or a block including data of the transaction, among other data (e.g., public key, certificate, subject).

At operation 720, the second node 704 may verify the transaction. For example, the second node 704 may parse the transaction (e.g., content of the certificate) to determine whether the transaction is a valid transaction (e.g., rather than a false transaction). In some cases, the transaction may not include a certificate, or the content of the certificate may include an error (e.g., an incorrect format, wrong encryption keys). The second node 704 may not validate the transaction and the process may end. If the second node 704 parses the transaction and determines the transaction is a valid transaction, then the second node 704, at operation 722, may sign the transaction (e.g., a second certificate for the transaction). At operation 724, the second node 704 may transmit a transaction message 724 to the notary system 706.

The notary system 706 may include the chosen notary service. The notary system 706 may receive the transaction message 724. The transaction message 724 may include the transaction, the signed certificates, or the block, among other data. The notary system 706 may verify the signatures and, at operation 726, notarize the transaction. The notary system 706 may send notary messages 728 to the first node 702 and the second node 704 indicating notarization of the transaction. At operation 728, the first node 702 may record the transaction (e.g., append the block onto a local copy of a blockchain). At operation 730, the second node 704 may record the transaction (e.g., append the block onto a local copy of a blockchain).

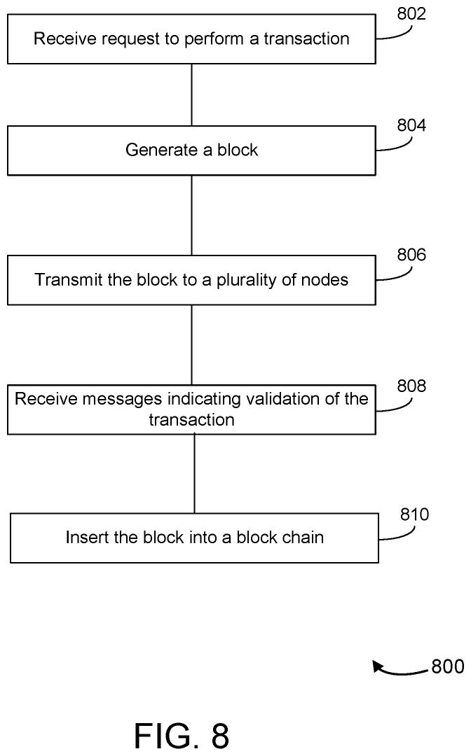

FIG. 8 depicts a method 800 for virtual and physical tracking of assets, in accordance with an implementation. The method 800 can be performed by one or more systems or components depicted in FIGS. 1-7, including, for example, a computing system 102, a blockchain platform 126, or a node 130. The method 800 may include more or fewer operations and the operations may be performed in any order.

At operation 802, the computing system can receive, from a first node of multiple nodes, a request to perform a transaction. The transaction may be of an asset between the first node and a second node of the multiple nodes. The transaction may include a transfer of the asset between the first node and the second node. Each node of the multiple nodes may be a tokenized representation of a respective physical entity for managing assets. In some arrangements, the physical entities may at least include one of an ATM, a teller view, a cash vault, a branch vault, a teller cash line, a TCR, or a CDR. In some arrangements, the request can include a first identification for the first node, a second identification for the second node, an amount for the transaction, and a signature associated with a private key of the first node. In some arrangements, the multiple nodes at least include one of an ATM node, a teller view node, a cash vault node, a branch vault node, a teller cash line node, a TCR node, or a CDR node. In some arrangements, each of the multiple nodes includes a proof of identity. In some arrangements, the proof of identity may be an X509 certificate.

At operation 804, the computing system can generate a block. The block may at least include a pointer, a block identification, and data associated with the transaction. In some arrangements, the computing system can verify the signature of the request via a public key based on receiving the request. The computing system can generate the block based on verifying the signature. In some arrangements, the data may be structured according to a data structure formulated based on a destination identification field, an amount field associated with the transaction, and a source identification field.

At operation 806, the computing system can transmit the block to each of the multiple nodes. At operation 808, the computing system can receive, from each of the multiple nodes, a respective message indicating validation of the transaction. In some arrangements, the computing system can transmit, to the second node, the request based on the verification to cause the second node to verify the request. The computing system can receive, from the second node, a message including the request and a second signature associated with a second private key of the second node. Responsive to receiving the message including the second signature, the computing system can transmit, to each of the multiple nodes, the message. The computing system can receive, from each of the multiple nodes, the respective message including the request and a respective signature associated with each of the multiple nodes.

At operation 810, the computing system can append the block onto a blockchain based on receiving the validation. The blockchain may include a plurality of blocks each associated with a respective transaction between two nodes of the multiple nodes. In some arrangements, responsive to appending the block onto the blockchain, the computing system can transmit, to each of the multiple nodes, a copy of the blockchain. In some arrangements, each block of the blockchain is encrypted by a key established using a QKD.

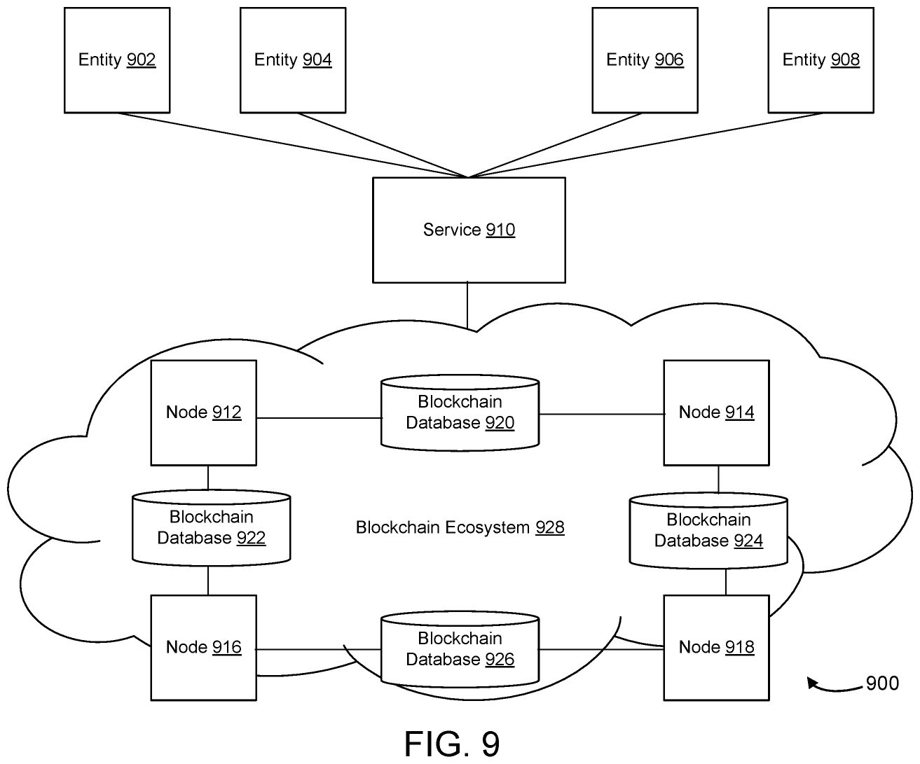

FIG. 9 depicts an example system 900 for virtual and physical tracking of assets, according to an arrangement. The system 900 may include physical entities 902, 904, 906, and 908, a service 910, and a blockchain ecosystem 928. The blockchain ecosystem 928 may include nodes 912, 914, 916, and 918, and blockchain databases 920, 922, 924, and 926. In some cases, the service 910, the blockchain ecosystem 928, the nodes 912-918, and the blockchain databases 920-926 may be respective examples of the cloud services 204, the blockchain platform 212, the nodes 206, and the blockchain vaults 210, as described herein with reference to FIG. 2. Each physical entity 902-908 may be in communication with the service 910 (e.g., wireless communication, wired communication).

In some examples, the physical entity 902 may be a treasury, the physical entity 904 may be a TCR cash line, the entity 906 may be a teller cash line, and the physical entity 908 may be an ATM. The node 912 may be a treasury node that includes information (e.g., asset information, identification information, etc.) for the physical entity 902. The node 914 may be a TCR node that includes information (e.g., asset information, identification information, etc.) for the physical entity 904. The node 916 may be a teller node that includes information (e.g., asset information, identification information, etc.) for the physical entity 906. The node 918 may be an ATM node that includes information (e.g., asset information, identification information, etc.) for the physical entity 908. In some cases, the nodes 912-918 may reside on physical hardware (e.g., in memory of a control device of the physical entities, on a computer located at a location of the physical entities) of the respective physical entities 902-908.

Each node 912-918 may have a respective blockchain database 920-926. For example, the blockchain databases 920-926 may be a distributed network, where each blockchain database 920-926 includes a respective copy of a blockchain. In some cases, in response to a client performing a transaction at the physical entity 902, the node 912 of the physical entity 902 may update a blockchain copy of the blockchain database 920. The node 912 may communicate the update to the other nodes 914-918 to update respective blockchain copies of the blockchain databases 922-926.

The subject matter including the operations described in this specification can be implemented in multiple types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or arrangement, and references to “an implementation,” “some implementations,” “one implementation” or the like are not necessarily mutually exclusive and are intended to indicate that a particular feature, structure, or characteristic described in connection with the implementation may be included in at least one implementation or arrangement. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
one or more processors coupled with memory and configured to:
receive, from a first node of a plurality of nodes, a request to perform a transaction of an asset between the first node and a second node of the plurality of nodes, wherein each node of the plurality of nodes is a tokenized representation of a respective physical entity for managing assets;
generate a block comprising: i) a pointer, ii) a block identification, and iii) data associated with the transaction;
transmit the block to each of the plurality of nodes;
receive, from each of the plurality of nodes, a respective message indicating validation of the transaction; and
append the block onto a blockchain, the blockchain comprising a plurality of blocks each associated with a respective transaction between two nodes of the plurality of nodes.

2. The system of claim 1, wherein the one or more processors are further configured to:
responsive to appending the block onto the blockchain, transmit, to each of the plurality of nodes, a copy of the blockchain.

3. The system of claim 1, wherein the request comprises a first identification for the first node, a second identification for the second node, an amount for the transaction, and a signature associated with a private key of the first node.

4. The system of claim 3, wherein the one or more processors are further configured to:
verify the signature of the request via a public key based on receiving the request; and
transmit, to the second node, the request based on the verification to cause the second node to verify the request.

5. The system of claim 4, wherein the one or more processors configured to receive the message from each of the plurality of nodes are further configured to:
receive, from the second node, a message comprising the request and a second signature associated with a second private key of the second node;
responsive to receiving the message comprising the second signature, transmit, to each of the plurality of nodes, the message; and
receive, from each of the plurality of nodes, the respective message comprising the request and a respective signature associated with each of the plurality of nodes.

6. The system of claim 1, wherein the plurality of nodes are tokenized representations of a plurality of physical entities, the physical entities at least comprising one of an automated teller machine (ATM), a teller view, a cash vault, a branch vault, a teller cash line, a teller cash recycler (TCR), or a cash deposit recycler (CDR), and the plurality of nodes at least comprises one of an ATM node, a teller view node, a cash vault node, a branch vault node, a teller cash line node, a TCR node, or a CDR node.

7. The system of claim 1, wherein the data is structured according to a data structure formulated based on: i) a destination identification field, ii) an amount field associated with the transaction, and iii) a source identification field.

8. The system of claim 1, wherein each block is encrypted by a key established using a quantum key distribution (QKD).

9. The system of claim 1, wherein each of the plurality of nodes comprises a proof of identity.

10. The system of claim 1, wherein the transaction comprises a transfer of the asset between the first node and the second node.

11. A method comprising:
receiving, by one or more processors from a first node of a plurality of nodes, a request to perform a transaction of an asset between the first node and a second node of the plurality of nodes, wherein each node of the plurality of nodes is a tokenized representation of a respective physical entity for managing assets;
generating, by the one or more processors, a block at least comprising: i) a pointer, ii) a block identification, and iii) data associated with the transaction;
transmitting, by the one or more processors, the block to each of the plurality of nodes;
receiving, by the one or more processors from each of the plurality of nodes, a respective message indicating validation of the transaction; and
appending, by the one or more processors, the block onto a blockchain based on receiving the validation, the blockchain comprising a plurality of blocks each associated with a respective transaction between two nodes of the plurality of nodes.

12. The method of claim 11, further comprising:
responsive to appending the block onto the blockchain, transmitting, to each of the plurality of nodes by the one or more processors, a copy of the blockchain.

13. The method of claim 11, wherein each of the plurality of nodes comprises a proof of identity.

14. The method of claim 11, wherein the request comprises a first identification for the first node, a second identification for the second node, an amount for the transaction, and a signature associated with a private key of the first node.

15. The method of claim 14, further comprising:
verifying, by the one or more processors, the signature of the request via a public key based on receiving the request; and
transmitting, by the one or more processors to the second node, the request based on the verification to cause the second node to verify the request.

16. The method of claim 15, wherein receiving the message from each of the plurality of nodes comprises:
receiving, by the one or more processors from the second node, a message comprising the request and a second signature associated with a second private key of the second node;
responsive to receiving the message comprising the second signature, transmitting, by the one or more processors to each of the plurality of nodes, the message; and
receiving, by the one or more processors from each of the plurality of nodes, the respective message comprising the request and a respective signature associated with each of the plurality of nodes.

17. The method of claim 11, wherein the plurality of nodes are tokenized representations of a plurality of physical entities, the physical entities at least comprising one of an automated teller machine (ATM), a teller view, a cash vault, a branch vault, a teller cash line, a teller cash recycler (TCR), or a cash deposit recycler (CDR), and the plurality of nodes at least comprises one of an ATM node, a teller view node, a cash vault node, a branch vault node, a teller cash line node, a TCR node, or a CDR node.

18. The method of claim 11, wherein the data is structured according to a data structure formulated based on: i) a destination identification field, ii) an amount field associated with the transaction, and iii) a source identification field.

19. A non-transitory computer readable storage medium comprising instructions stored thereon that, when executed by a processor, cause the processor to:
receive, from a first node of a plurality of nodes, a request to perform a transaction of an asset between the first node and a second node of the plurality of nodes, wherein each node of the plurality of nodes is a tokenized representation of a respective physical entity for managing assets;
generate a block comprising: i) a pointer, ii) a block identification, and iii) data associated with the transaction;
transmit the block to each of the plurality of nodes;
receive, from each of the plurality of nodes, a respective message indicating validation of the transaction; and
append the block onto a blockchain, the blockchain comprising a plurality of blocks each associated with a respective transaction between two nodes of the plurality of nodes.

20. The medium of claim 19, comprising instructions stored thereon that, when executed by the processor, cause the processor to:
responsive to appending the block onto the blockchain, transmit, to each of the plurality of nodes, a copy of the blockchain.
